(19) United States
(12) Patent Application Publication
(10) Pub. No.: US 2013/0275576 A1
(43) Pub. Date: Oct. 17, 2013

(54) Network condition-based monitoring analysis engine

(71) Applicants: Michael Hinz, Houston, TX (US); William Hinz, Katy, TX (US)

(72) Inventors: Michael Hinz, Houston, TX (US); William Hinz, Katy, TX (US)

(73) Assignee: YR20 Group, Inc., Houston, TX (US)

(21) Appl. No.: 13/506,322

(22) Filed: Apr. 11, 2012

(51) Int. Cl. G06F 15/173

(52) U.S. Cl. 709/224

(57) ABSTRACT

The present disclosure relates to profiling industrial networks as part of an engineering, commissioning, modification, maintenance, or repair process. The comparison of a current running profile of an industrial network to previous or archived profiles provides unique information for the commissioning, modification, maintenance, or repair of the network. Further, the comparison of the current running profile of a network to reference profiles is provided. Generally, a network condition-based monitoring analysis engine is provided.

### TECHNICAL FIELD

The present disclosure relates to the field of digital communications. More particularly, the present disclosure relates to profiling industrial networks as part of an engineering, commissioning, modification, maintenance, or repair process. Further, the present disclosure relates to the field of comparing a current running profile of an industrial network to previous or archived profiles, or comparing the current running profile of a network to one or more reference profiles. A network condition-based monitoring analysis engine is provided.

### BACKGROUND

Current engineering practices provides for the calibration, measurement, commissioning, maintenance, and repair of equipment, articles, devices and the like. Such practices are typically based on standardized methods and tools. The standardization of methods and tools for the calibration, measurement, commissioning, maintenance, and repair of equipment dates back to the mid 1800s. Similar standards can be applied to computer systems and networks, where it is desirable to monitor network traffic and compare current monitored metrics with one or more previous values, and/or one or more reference or standardized values.

FIG. 1 illustrates a simplified view of the lifecycle of such system, and includes the general steps: Requirements→Design/Procure/Build→Install/Commission→Operate→De-Commission. The key loops of the lifecycle of a system are the Maintenance and Repair Cycle (1) and the Modify Cycle (2). Both the Maintenance and Repair Cycle (1) and the Modify Cycle (2) require Commissioning, which is the objective process of assuring and documenting that the system meets the operational requirements upon which the system was designed. The commissioning process in all branches of engineering has long-involved formal test methods and test records. The test methods and test records then form part of the system documentation that endures until the system is de-commissioned.

Cycle (1), the Maintenance and Repair Cycle, typically involves a determination of whether the system is running appropriately. Typically, such a determination requires taking measurements at one or more specified test-points, designed and built into the system, in order to confirm that the system is operating correctly. If one or more measurements indicate a deviation from the documented commissioning state, an evaluation of how and where the running-system deviates, and what must be done to bring the system back into compliance, can be determined.

Cycle (2), the Modify Cycle, typically involves confirming that changes expected from a modification are present, developing an understanding of the new re-commissioned state, and documenting the new re-commissioned state. The Modify Cycle (2) routinely involves taking measurements at test-points, designed and built into the system, in order to confirm that the changes expected from the modifications are present and to understand and document the new re-commissioned state. For example, if a deviation is noted during the maintenance and repair cycle (1), but it is determined that this deviation occurred due to a legitimate condition or change in the system, or alternatively, if a change is implemented for which a deviation in the value(s) noted during the maintenance and repair cycle (1) would be noted, the modify cycle (2) can be used to determine whether expected changes are present and what such changes may be, and update the commissioned (e.g., normal or baseline) state of the system to account for this change. Deviations for which there is not a legitimate condition or change can be indicative of a need for corrective modifications to restore the system to its commissioned state, which can also be verified using the modify cycle (2).

There is a long history of engineering tools and methods for commissioning, documenting, maintaining, and repairing analogue electronic and communication systems. However, as many of these communication systems have moved from analogue to digital/Ethernet/network, there is a lack of tools and methods to commission, document, maintain, and compare current-state to commissioned-state, and to re-commission these new systems.

Digital/Ethernet/network technologies have become widely used as industrial fieldbusses, industrial network trunks, and for various other critical systems and uses. Thus, it can be appreciated that the magnitude of the need to accurately control and maintain such systems is paramount. No such tools, methods or systems are known for commissioning, documenting, maintaining, and repairing digital/Ethernet/network technologies and products.

Network condition-based monitoring analysis is applicable with respect to all fundamental technology building blocks that are in the public domain. Examples of applicable fundamental technology building blocks can include IEEE 802 series standards (Ethernet, etc.); ISO X series standards (OSI, etc.); IETF RFC standards (TCP/IP, etc.); IEC and ITIL Standards and engineering practices covering maintenance and lifecycle management of programmable electronic systems; FSF GPL licensed software (Linux, LibPCAP, gcc, glibc, etc.); Commercial Test & Measurement products, systems and services; and Classification Societies offering commercial services that certify industrial systems and facilities for insurance purposes.

Embodiments of usable applications are related to IEEE and Ethernet Standards. Examples of such relevant standards are Xerox (Ethernet I), U.S. Pat. No. 4,063,220, which is incorporated herein by reference; Dec, Intel and Xerox collaborated Ethernet II (aka DIX Ethernet), 1980, aka IEEE draft standard; and the IEEE formed project 802, which is still running and generates all the IEEE 802 series standards that completely dominate LANs today, and are cross-standardized by ISO, IEC, etc.

Also relevant are the ISO Standards, now ISO & ITU Open Systems Interconnect (OSI). Examples of such relevant standards are the 7-layer network model including Layer-2 Data-Link Layer (e.g. Ethernet), Layer-3 Network Layer (e.g. the Internet Protocol) and Layer-4 Transport Layer (e.g. the User Datagram Protocol or the Transmission Control Protocol); and the ITU X.200 series of standards.

Further relevant are the IETF Standards including TCP/IP, etc. Examples of such relevant standards are those developed by the U.S. Defense Advanced Research Project Administration (DARPA) and Standards published by the Internet Engineering Task Force (IETF) as RFCs (there are 7000+ RFCs currently).

Still further, relevant are IEC Standards. Examples of relevant IEC Standards are IEC Standard 61508 which covers the safety lifecycle of electrical/electronic/programmable electronic safety-related systems, and which covers analysis, realization and operation on a lifecycle basis, whereby the standard defines System Integrity Levels 1 through 4.

Further, ITIL Practices are relevant and bring strong standards and processes to corporate IT service management. The ITIL practices cover all IT service management aspects including; problem management, change management, capacity management, infrastructure deployment and operations management.

In addition, commercial test and measurement systems are relevant. Electronic test & measurement systems are as old as electronics, originally performed using signal generators and oscilloscopes. Commercial Ethernet and TCP/IP test & measurement systems, often called “LAN Analyzers” or “Packet Sniffers” are almost as old as the standards themselves. The dominant early suppliers were Network General and Hewlett-Packard. There have been many commercial “test and measurement” (T&M) hardware and software suppliers over the last 25 years.

Further relevant are Free Software Foundation (FSF) and General Public Licensed (GPL) Software (i.e., Open-Source or Free). As the power of commodity computers has increased, the need for specialized high-cost hardware from the commercial Test & Measurement suppliers has declined. Exemplary technologies used within the FSF and GPL market include Wireshark/Tshark, provided by CACE Technologies. The TCPDump project controls the Packet CAPture (PCAP) file format for the storing of Layer-2 frames captured from a network and provides the LibPCAP software library for reading and writing PCAP files. TCPTrace, NTOP and others are analysis software systems released under the FSF/GPL.

Other commercial presences in the marketplace include classification societies such as Lloyds of London (LL) and Det Norske Veritas (DNV), which certify industrial facilities and the associated management tools and processes. The resulting certification enables facility-owners to obtain insurance coverage. Typically, DNV promotes its Integrated Software-Dependent Systems (ISDS) certification service to maritime and energy customers. This involves the formal certification of software-based systems, and therefore any associated network.

Network condition-based monitoring analysis is required in both the Maintenance and Repair (1) and Modify (2) loops within the lifecycle of critical industrial systems as illustrated in FIG. 1.

Thus, there is a great need to extend standardized methods and tools for measurement, commissioning, maintenance and repair into the industrial use of network systems. Particularly, there is a great need to extend standardized methods and tools for measurement, commissioning, maintenance and repair into IEEE802.3, Ethernet and TCP/IP.

Typically, an Ethernet or similar network is monitored by capturing files (e.g., PCAP files) from a specific test point in the network over a period of time, then identifying changes in network traffic and/or other parameters over time to determine potential problems that may require corrective modifications. PCAP files include numerous binary packets, which can be converted into values for various parameters (e.g., key metrics); however, raw data obtained in this manner is unusable by and incomprehensible to all but the most skilled professionals.

A need exists for systems and methods usable to transform raw data associated with a network to an individually readable form, such as an array, enabling values for key metrics associated with individual PCAP files and/or time intervals to be viewed alongside one another, and/or alongside reference/standard values, thus enabling efficient visual detection of deviations in a network, usable for monitoring, managing, maintaining, and/or modifying a network responsive to this output.

### SUMMARY

Embodiments usable within the scope of the present disclosure relate to computer-implemented methods and systems for transforming raw data (e.g., data that is not readily readable and/or understandable by an individual) associated with one or more capture files obtained from a network to form an array or similar individual readable data (e.g., data readily readable and/or understandable by an individual) usable for monitoring, analyzing, modifying, optimizing, and/or otherwise changing or observing the network, thereby enabling parallel analysis for a plurality of network capture files. For purposes of this disclosure and claims herein, the term “capture file” can include any manner of file containing data associated with communication, transmission, and/or traffic over a network, including without limitation: packet capture (PCAP) files, .cap files (e.g., obtained through use of Network Associates Sniffer) and/or similar capture files, such as those obtained through use of Wireshark, Tshark, Tcpdump, Microsoft Network Monitor, and/or other similar programs. Additionally, for purposes of the disclosure and claims herein, the term “array” can be synonymously used with the term “individual readable data,” to indicate any form, organization, or type of information that can be readily understood and processed by an individual without requiring significant additional transformation thereof.

Systems and methods of the present disclosure can be implemented in any appropriate programming language on any computer or similar device. In an embodiment, raw data associated with one or more capture files is received, the raw data including metrics associated with respective capture files. The raw data is transformed to form an array or similar individual readable data that associates each capture file with one or more respective metrics.

For example, a plurality of capture files can be received from a test point of a network, each at a respective point in time. After transformation of the data into a human-readable format, the resulting output can include, for example, an array having a first axis associated with respective capture files, and a second axis associated with respective key metrics. Thus, a resulting array can include columns (or rows), each associated with a single capture file, and rows (or columns), each associated with a single key metric, thereby defining cells, each cell populated by a value associated with the key metric of the associated row and the capture file of the associated column. Such an output enables desired metric values for multiple files and/or time periods and/or reference/standard files to be viewed side-by-side, in an individual readable form usable for network analysis, monitoring, modification, etc. Further embodiments can include computer-implemented filtering of the output data, triggering of alerts if selected values fall outside of selected thresholds, production of graphs and/or other types of reports, and/or other similar forms of data processing and analysis.

The capture files can be analyzed in a two-pass process. For example, a pre-processing looping read can be performed through one or more retrieved capture files to verify that the files comprise valid inputs, and data structures for retaining data associated with the capture files that can be built. Analysis of packets associated with the capture files can be performed to obtain values for metrics and submetrics that are stored in an extensible data structure, usable to accommodate for varied analysis. At the end of the analysis process, the metrics and submetrics, that are stored in the extensible data structure, can be written to an array or other forms of individual readable output, such as a “Comma-Separated Value” (CSV) data file on a POSIX-compliant computer system. The resulting CSV file or other individual readable output can be viewed through “Commercial Off The Shelf” (COTS) or commodity software, such as a spreadsheet program, or could be further analyzed, filtered, processed, and/or used to produce graphs, reports, etc., using other programs or applications.

The systems, methods, and software programs of the present disclosure, can be of use to engineers of high-value computer networks, often industrial, in the engineering, commissioning, modifying, maintaining, and repairing of such networks. In one embodiment, the system and method, in the form of a network condition-based monitoring analysis engine, is implemented in the C language on a POSIX-compliant computer with a Command-Line Interface (CLI).

Embodiments usable within the scope of the present disclosure can therefore include a set of capture file analysis metrics and submetrics that provides a detailed profile and quality of service analysis for the traffic on an Ethernet Access or Trunk circuit. Such an analysis can cover OSI Layer-2, Layer-3 and Layer-4 structures, and extend on a per-VLAN basis for Trunk circuits. This allows a per-VLAN granular view for better analysis. Metrics and submetrics can be re-normalized to a per-second analysis to allow a normalized view independent of the duration of any of the capture files.

The system and method of the present disclosure may, for example, be used for system engineering in which analysis data is usable to profile the traffic of a network and/or create a known reference profile, for system commissioning to check and document any deviations from a commissioned state of a system, for system maintenance (e.g., for comparison to files captured from previous intervals or standard commissioning records), and for system repair to identify any deviations from a known good commissioned state, verifying the success of modifications to remedy such deviations, and/or recommissioning a system as needed to account for legitimate changes.

Also, embodiments of the present systems and methods may be used for side-by-side analysis of multiple capture files, to provide a comparison of selected metrics or submetrics, on different systems and/or at different times. Each metric or submetric may be listed in different columns in the same row, or different rows in the same column, to make rapid comparison very simple. The system output can be extended to include a large number of columns and rows to accommodate a large number of captured and/or reference files and a large number of metrics. The metrics and submetrics can be normalized to per-second values to allow simple comparison of a range of capture files of different sizes and durations.

Thus uses for embodied systems and methods can include engineering/commissioning of systems, such as that depicted in the cycles (1, 2), shown in FIG. 1, to compare and document systems before and after modifications, to compare the current system to a known good reference or references or previous states of the system, and for management of a system's operational integrity, security, intrusion detection (e.g., detection of anomalous network traffic or the absence of nominal network traffic), or other similar purposes. For example, if a selected key metric value is substantially constant over many intervals, then significantly changes in a manner that would indicate unauthorized traffic and/or devices, an array or similar individual readable output produced, using embodiments of the present systems and methods, can make evident such deviations from the normal state of a network.

### BRIEF DESCRIPTION OF THE DRAWINGS

The accompanying drawings, which are incorporated in and constitute a part of this specification, illustrate an implementation of apparatus consistent with the present disclosure and, together with the detailed description, serve to explain advantages and principles consistent with the disclosure. In the drawings:

FIG. 1 illustrates a simplified flow chart of the lifecycle of a system according to the present disclosure.

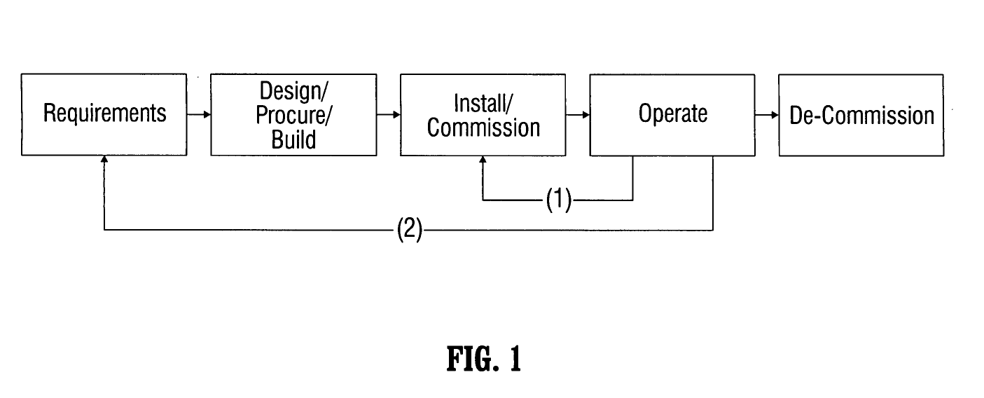

FIG. 2 is a flowchart illustrating an embodiment of a summary flow of a network condition-based monitoring analysis engine usable within the scope of the present disclosure.

FIG. 3 is a diagram illustrating an embodiment of the network condition-based monitoring analysis engine usable within the scope of the present disclosure.

FIG. 4 illustrates an embodiment of the inputs for the network condition-based monitoring analysis engine of the present disclosure.

FIG. 5 illustrates an embodiment of the outputs of the network condition-based monitoring analysis engine of the present disclosure.

FIG. 6 illustrates the data structures associated with the network condition-based monitoring analysis engine of the present disclosure.

FIG. 7 illustrates an example of individual readable output associated with the network condition-based monitoring analysis engine of the present disclosure.

The above general description and the following detailed description are merely illustrative of the generic invention, and additional modes, advantages, and particulars of this invention will be readily suggested to those skilled in the art without departing from the spirit and scope of the invention.

### DESCRIPTION OF EMBODIMENTS

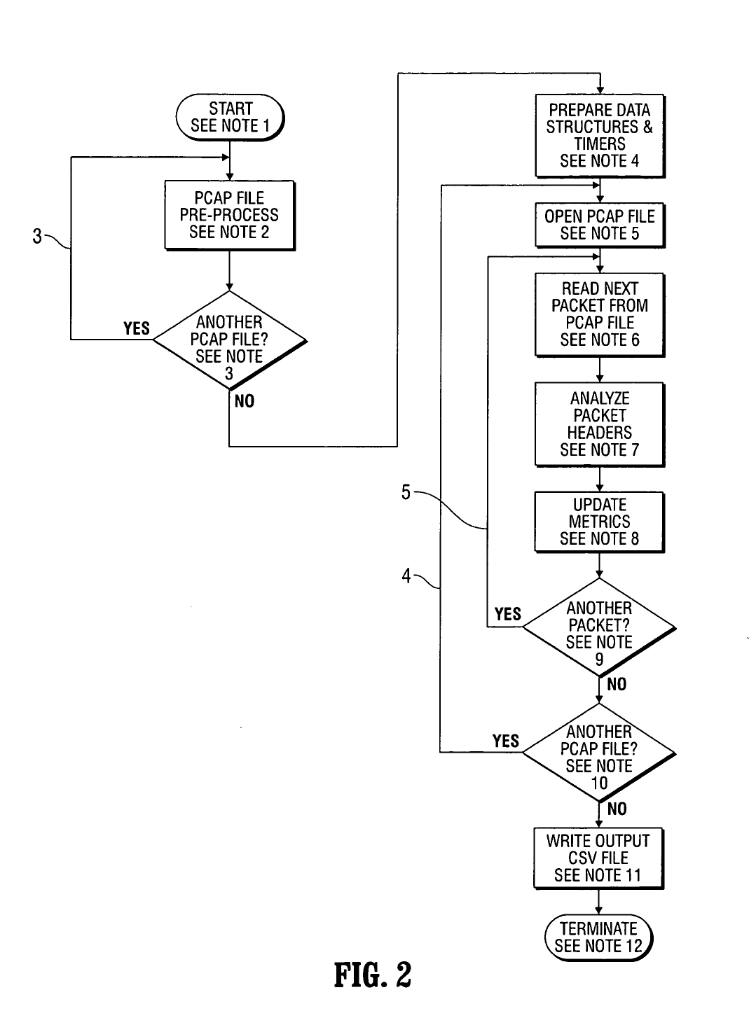

FIG. 2 is a flowchart illustrating a summary flow of an embodiment of a network condition-based monitoring analysis engine (Net-CAE) of the present disclosure. While FIG. 2 depicts an embodiment of the process performed by the engine with respect to a plurality of packet capture (PCAP) files, it should be understood that use of the PCAP format is an exemplary embodiment, and that any type of capture file could be similarly processed using the embodied engine and process.

In summary, FIG. 2 depicts an embodiment of a process that includes three loops. First, a loop (3) through all the PCAP files listed as inputs on the Command Line Interface (CLI) is performed to check their integrity and to extract file metadata such as name, duration, etc. Second, an outer loop (4) through all the PCAP files listed as inputs on the Command Line Interface (CLI) is performed. This is followed by an inner loop (5) through all the packets in a PCAP file to read the packet dates/times and compute all traffic, OSI Layer-2, Layer-3, Layer-4, and/or any other metrics, and update the data matrix structures with the metrics. Lastly, the PCAP file metadata and internal metric accumulator data matrix structures can be written to an individual readable output (e.g., a CSV file).

In one embodiment, the Net-CAE system and method of the present disclosure can use “third generation,” “structured programming” software (e.g., C language source code) that operates in a POSIX-compliant Command Line Interface (CLI) environment and follows the well-established conventions of that environment. However, it can be appreciated by those skilled in the art that other different programming software can readily be used to implement the systems and methods of the present disclosure.

Generally, the Net-CAE process proceeds in two phases. The first phase includes the pre-process looping read (3) through the input PCAP files, described above, to check that all the inputs are valid and to build the necessary data structures. The second phase is a main processing section that includes the outer and inner loops (4, 5), described above. The outer loop (4) relates to the list of input PCAP files, while the inner loop (5) relates to the list of packets in a specific PCAP file. In operation, packets from a single PCAP file can be sequentially analyzed and the obtained metric data can be input into the data structures (the inner loop), then, the next PCAP file can be opened for analysis (the outer loop). This process can continue until the packets of each PCAP file input have been analyzed.

Within the inner loop (5), FIG. 2 depicts process steps, “Analyze Packet Headers” and “Update Metrics,” which can occur after a packet of a PCAP file is read. The Analyze Packet Headers step can include use of branching logic to identify the OSI Layer-2, Layer-3 and Layer-4 identifiers of the packet (addresses, protocol identifiers, port numbers, etc.) as well as sequence numbers, etc. The Update Metrics step can use the information from the Analyze Packet Headers step to add or update values for metrics to the data structures built during the pre-processing loop.

After all input PCAP files have been processed, the Net-CAE system and method can write the accumulated data to an individual readable format (e.g. a CSV file and/or an array or similar format) for output and use by a user and/or a subsequent program.

The steps depicted in FIG. 2 can be more clearly understood using the following reference NOTES, referenced in FIG. 2:

NOTE 1: The program starts. The program checks software license availability. The program parses CLI input to obtain input PCAP file name(s) and an output CSV file name, and a time interval value. The program checks that input PCAP file(s) exist and that an output CSV file or other suitable format can be opened.

NOTE 2: During the depicted initial loop (3), successive PCAP files listed on the CLI input -i flag are opened and read sequentially from the first packet to last packet to check for integrity and readability. The date and time of first and last packets in each PCAP file can be recorded and PCAP file duration can thereby computed. The list of all VLANs seen in all PCAP files can assembled during this loop (3).

NOTE 3: The list of PCAP files provided via the CLI input -i flag can be pre-processed in turn and in order via this decision loop. Once each PCAP file has been pre-processed, and/or it is decided that no additional PCAP files will be pre-processed, the main processing section (e.g., the outer and inner loops (4, 5)) of the Net CAE process can begin.

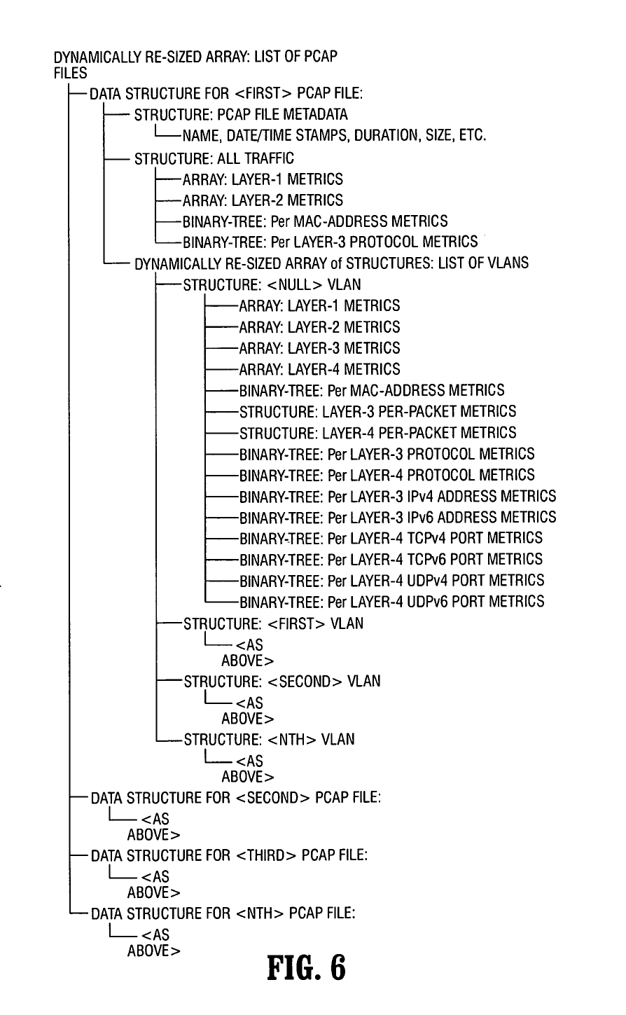

NOTE 4: The temporary/working data variables and accumulating final-output data variables and structures are initialized. (An embodiment of data structures usable within the scope of the present disclosure is shown in FIG. 6.)

NOTE 5: This step begins the “outer loop” (4) of the NET CAE process. Successive PCAP files listed on the CLI input -i flag are sequentially opened.

NOTE 6: This step begins the “inner loop” (5) of the NET CAE process. Successive packets of the open PCAP file are sequentially read.

NOTE 7: Each packet is analyzed into its hierarchical layers: All layers metrics; [Optional Layer-2 shim] VLAN with 802.1Q ID and 802.1P Priority; Layer-2 Ethernet with 802.3 Addresses, metrics, etc.; [Optional Layer-3 if present] e.g. Internet Protocol (IP) with Addresses, metrics, etc.; [Optional Layer-4 if present], e.g., Transmission Control Protocol (TCP) with Port Numbers, metrics, analysis, etc.; and all the above can be analyzed using the published IEEE, IETF and IANA Protocol Specifications and Assigned Numbers. While in an embodiment, data obtained from packets can be filtered and/or data relating only to certain metrics can be analyzed, it is generally preferable that all metric data be analyzed at this point, while the final system output can be filtered, to ensure that no relevant data is inadvertently excluded from analysis.

NOTE 8: Once the packet analysis is complete, obtained metric data is used to update the main data structures from the per-packet temporary data structures.

NOTE 9: The sequence of packets in the PCAP file is processed in turn and in-order via this decision loop. If all packets within the PCAP file have been processed and/or it is desired that no additional packets be analyzed, the inner loop (4) with respect to the open PCAP file can be concluded, and the outer loop (5) can proceed to the next PCAP file.

NOTE 10: The list of PCAP files provided via the CLI input -i flag is processed in turn and in order via this decision loop. If all PCAP files have been processed and/or it is desired that no additional PCAP files be processed, the outer loop (5), and thus the main processing section of the Net CAE process can conclude at this point.

NOTE 11: Once all packets in all PCAP files have been analyzed, an output file is created in an individual readable format (e.g., a CSV file, an array, etc.). In this step the output CSV file can be opened, and the output CSV file header information and main body rows can be written.

NOTE: 12: Upon termination of the process, the completion status is computed and set in the final exit( ) call so that any shell process can retrieve the status value, where 0 (zero) means normal successful completion, and non-zero means an error was encountered.

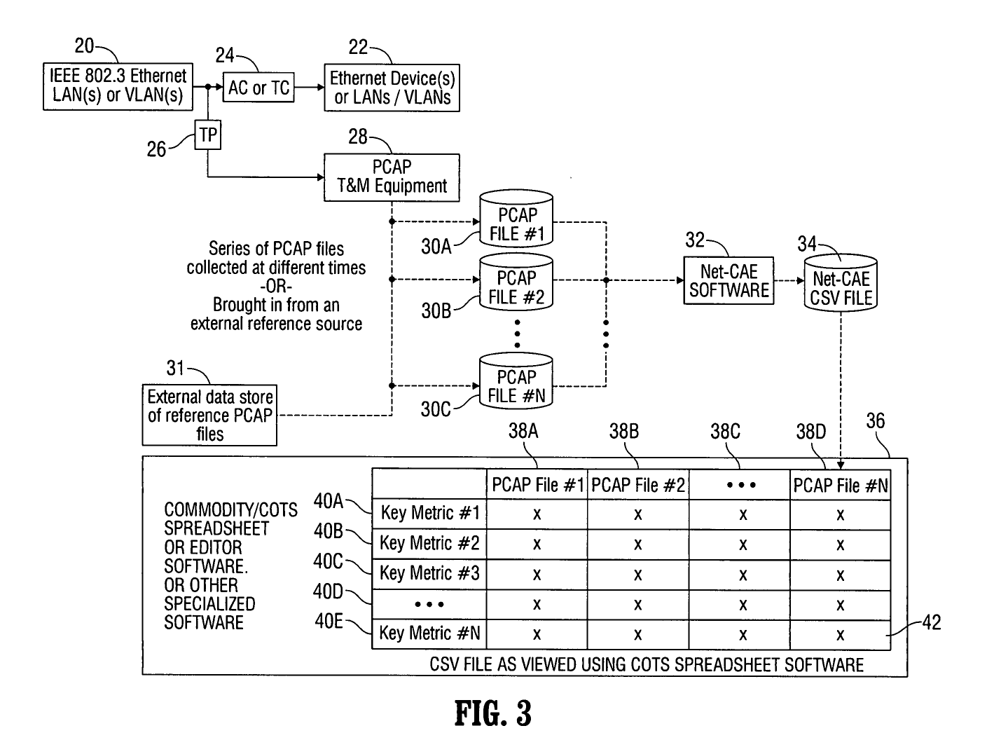

FIG. 3 is a diagram illustrating an overview of a system utilizing the network condition-based monitoring analysis engine of the present disclosure. While FIG. 3 depicts an embodiment of a system that processes packet capture (PCAP) files, it should be understood that use of the PCAP format is an exemplary embodiment, and that any type of capture file could be similarly processed using the embodied system.

FIG. 3 depicts a network (20), (e.g., an IEEE802.3 (Ethernet) standard network connection, LAN, and/or VLAN of any type). One or more Ethernet devices (22), LANs, and/or VLANs (e.g., an 802.1Q VLAN) are shown in communication with the network (20) via an Ethernet access circuit (24) (e.g., a copper or FO) and/or Ethernet trunk circuit (e.g., per IEEE802.1Q). The network (20) includes a test point (26) at which PCAP Test and Measurement Equipment (28) (e.g., Ethernet LAN Sniffer/Probe) is usable to record one or more PCAP files based on analyzed traffic from the network (20). The test point (26) can include a permanent in-line tap device, a temporary in-line tap, a mirror/span port on a switch, and/or any other type of suitable test point. Further, while FIG. 3 depicts a single test point (26), it should be understood that embodiments usable within the scope of the present disclosure can analyze multiple test points of a network, and/or multiple networks.

Specifically, FIG. 3 depicts a first PCAP file (30A), captured from the test point (26) at a first time, a second PCAP file (30B), captured from the test point (26) at a second time, and a reference PCAP file (30C), which can be acquired from any manner of external data source (31) or another source independent from or associated with the network (20). As described previously, embodiments usable within the scope of the present disclosure can be used to analyze a single PCAP file, or any number of PCAP files, and as such, the three depicted PCAP files (30A, 30B, 30C) shown in FIG. 3 are merely exemplary, and representative of any desired number of files. For example, a single PCAP file can be used in isolation with the Net-CAE system and method to characterize the traffic on the connection to be used for engineering/commissioning, modification or maintenance/repair work. Multiple PCAP files can be analyzed and compared to determine any irregularities in the network (20) that may indicate intrusion or other security issues, the presence of unexpected modifications, the absence of expected modifications, or other anomalies.

100611 Each of the depicted PCAP files (30A, 30B, 30C) can be processed using Net-CAE software (32) to form an output file (34) (e.g., a CSV file or similar individual readable format). Specifically, the Net-CAE software (32) can perform the process depicted in FIG. 2 and described above, and/or a similar/comparable process, thorough which each PCAP file (30A, 30B, 30C) is opened, packets from each PCAP file (30A, 30B, 30C) are analyzed, and metrics associated with each packet are added to associated data structures to form the output file (34). Use of a Comma-Separated Values (CSV) file can enable the output file (34) to be opened for viewing using almost any existing text editor software or spreadsheet software. A CSV file could also be an input to other specialized display or analysis software.

The output file (34) can then be processed for display, e.g., using spreadsheet software or other types of programs, to produce an individual readable output (36). While the specific format of the individual readable output (36) can vary, FIG. 3 depicts an exemplary embodiment in which the individual readable output (36) includes a table having a plurality of columns (38A, 38B, 38C, 38D), each column associated with an individual PCAP file (30A, 30B, 30C), and a plurality of rows (40A, 40B, 40C, 40D, 40E), each row associated with an individual key metric of the packets and/or PCAP files (30A, 30B, 30C). Individual cells are thereby defined, of which cell (42) is labeled for reference, each cell containing a value associated with the PCAP file of the respective column and the key metric of the respective row within which the cell is located. Thus, the individual readable output (36) shown in FIG. 3 is readily usable to compare data associated with numerous PCAP files, and with numerous key metrics, in a side-by-side manner, facilitating detection of any irregularities associated with traffic on the network (20). It should be understood that while FIG. 3 depicts a table having four depicted columns (38A, 38B, 38C, 38D) and five depicted rows (40A, 40B, 40C, 40D, 40E), the individual readable output (36) can have any number of rows and/or columns, or can include any other type of individual readable format. Further, in various embodiments, specialized software and/or other components can be used to selectively format, modify, filter, and/or otherwise manipulate the individual readable output (36). For example, values for key metrics that fall outside of a desired threshold could trigger an alarm and/or a visual indication (e.g., coloring and/or otherwise visually contrasting values that deviate from preselected norms). The individual readable output (36) could also be used to further generate graphs, charts, reports, etc., as desired.

Thus, the enhanced power of Net-CAE system and method appears when used as part of a coherent long-term commissioning, documenting, maintenance and repair lifecycle system. In the case of a lifecycle system, test and measurement equipment can be used to record PCAP files at pre-defined intervals or as required by a maintenance/repair philosophy. The list of available PCAP files taken at the same test-point can be compared using the Net-CAE system and method to determine metrics or other characteristics that remain constant, and what characteristics of a network have changed. By way of example, if the first PCAP file is a commissioning or reference file, one or more subsequent PCAP files are periodic maintenance files, and the final PCAP file is a fault-situation file, then the embodiments described herein can provide a clear view of the timeline of all metrics from commissioning or reference, through maintenance, to fault.

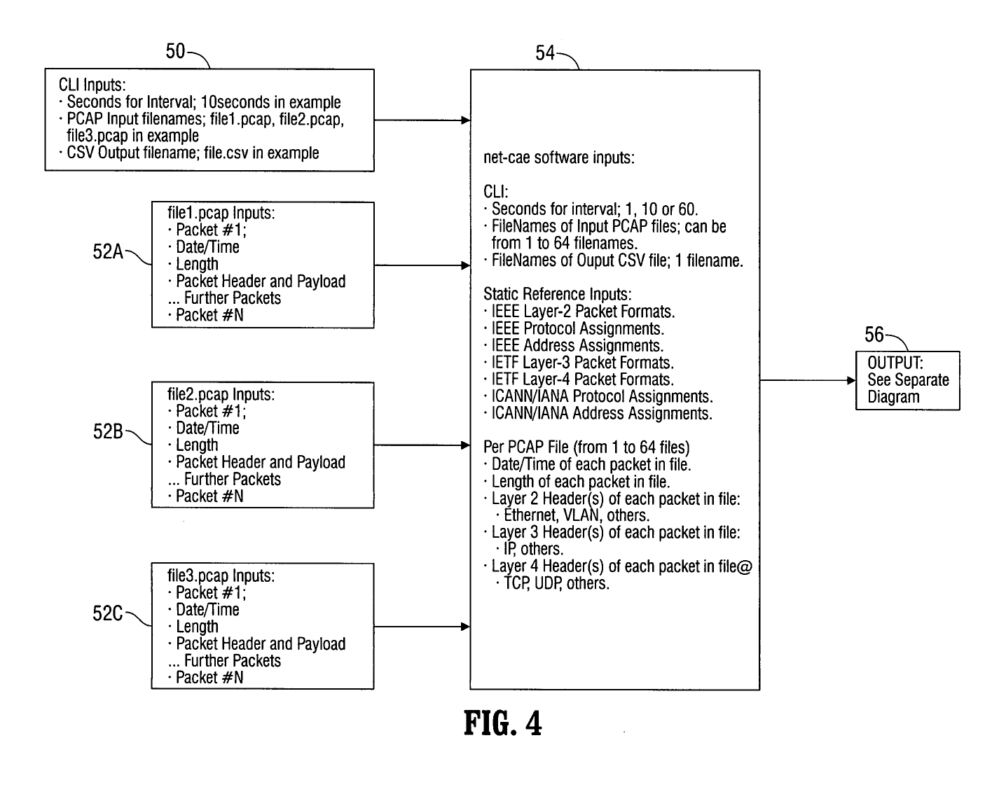

FIG. 4 illustrates an embodiment of the inputs usable with the network condition-based monitoring analysis engine of the present disclosure. While FIG. 4 specifically references inputs that include packet capture (PCAP) files, it should be understood that use of the PCAP format is an exemplary embodiment, and that embodiments of the present disclosure can include input of any numbers and type of capture file.

The Net-CAE system can accept a number of inputs, and can be adapted for a wide range of IEEE and ICANN/IANA address and protocol identifiers for OSI layers 2, 3 and 4. The runtime Command Line Interface (CLI) can take a number of inputs, such as the number of seconds to use for the sample interval, the names of one or more PCAP input files, and the name of one CSV output file. The PCAP files can then provide the major body of the input, such as for example, the date/time and length of each packet and the OSI Layer-2 and, optionally, Layer-3 and Layer-4 packet capture bytes to be analyzed.

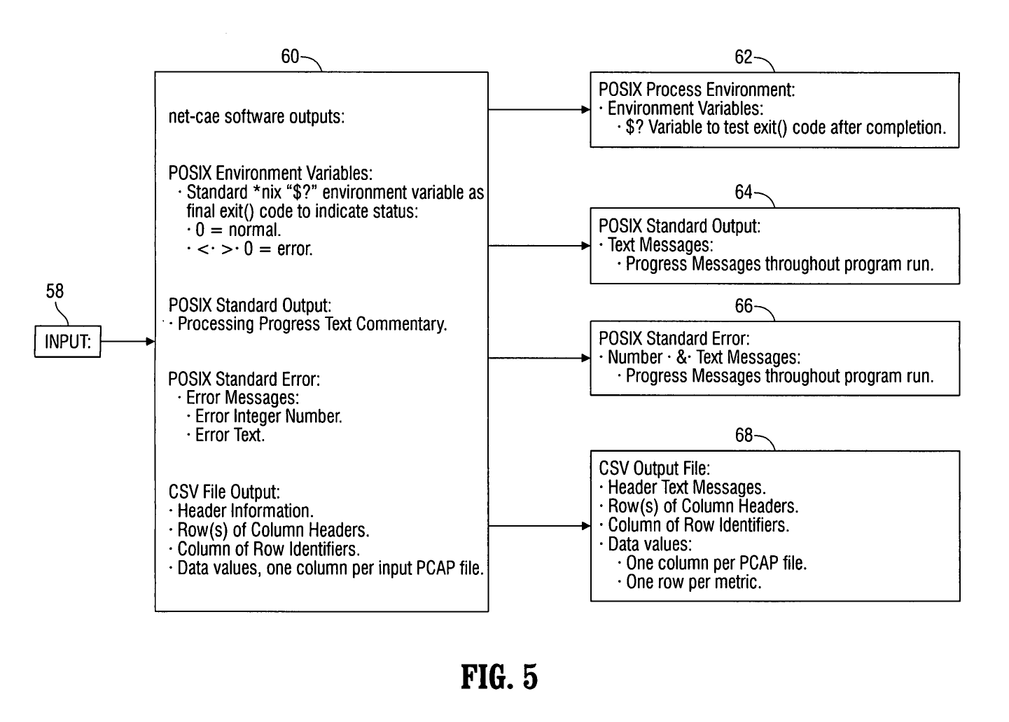

For example, FIG. 4 depicts CLI inputs (50) provided to the Net-CAE engine that can include a sample interval (e.g., 10 seconds, or another preferred value), the input filenames of one or more PCAP files (e.g., from 1 to 64 PCAP files), and the output file name of the individual readable data (e.g., a CSV file). FIG. 4 further depicts multiple PCAP file inputs (52A, 52B, 52C), each of which can include a plurality of packet data (e.g., date/time, length, packet header and payload) associated with each individual PCAP file. The Net-CAE software, itself, can therefore acquire and/or provide a plurality of engine inputs (54), which can include the CLI inputs (50) and PCAP file inputs (52A, 52B, 52C), as well as various static reference inputs (e.g., IEEE Layer-2 Packet Formats, IEEE Protocol Assignments, IEEE Address Assignments, IETF Layer 3 Packet Formats, IETF Layer-4 Packet Formats, ICANN/IANA Protocol Assignments, ICANN/IANA Address Assignments). The CLI inputs (50), PCAP file inputs (52A, 52B, 52C), and engine inputs (54) can be processed (e.g., using the process depicted in FIG. 2 or a similar/comparable process) to form outputs (56), which are further depicted and described in FIG. 5.

FIG. 5 illustrates an embodiment of the outputs of the network condition-based monitoring analysis engine of the present disclosure. Examples of outputs are POSIX environment variables, which can be used to enable any outer shell program to check the error and completion status after running Net-CAE; typical POSIX Command Line Interface (CLI) environment Standard Output of running commentary during the program run; typical POSIX Command Line Interface (CLI) environment Standard Error of any errors encountered during the program run; and typical POSIX Command Line Interface (CLI) environment output to a file, in this case a Comma-Separated Values (CSV) file.

The substance of the Net-CAE output is metadata for the entire Net-CAE system run, metadata for each PCAP file analyzed by the Net-CAE system, and Key Metrics for each capture file analyzed by the Net-CAE system. By way of example, the key metrics for a capture file may be provided in one or more columns (or rows), and the values for a specific key metric from each of the capture files may be in one or more rows (or columns), forming a chart, table, and/or array for rapid comparison of values.

FIG. 5 depicts the inputs (58) of the Net-CAE system, shown in greater detail in FIG. 4, responsive to which the system can provide Net-CAE software outputs (60), which can include POSIX Environment Variables (e.g., 0 indicates a normal output, while any other value indicates a possible error), POSIX Standard Output (e.g., processing progress text commentary), POSIX Standard Error(s) (e.g., error messages and/or error numbers/text), and/or individual readable output (e.g., a CSV output file, which can include header information, row/column identifiers, and data values, sorted into one column (or row) per PCAP file).

The final (e.g., end product) outputs of the system can include, by way of example, POSIX Process Environment Output (62) (e.g., variable(s) to test exit code after completion), POSIX Standard Message(s) (64) (e.g., text-based progress messages as the system is run), POSIX Standard Error(s) (66) (e.g., numbers and/or text identifying errors, and/or text messages indicating progress as the system is run), and an individual readable output (68), such as a CSV file (e.g., including header text messages, row(s) of column headers, column(s) of row identifiers, and data values (one column/row per PCAP file, one row/column per metric)).

FIG. 6 illustrates an embodiment of the data structures associated with the network condition-based monitoring analysis engine of the present disclosure. While FIG. 6 references use of packet capture (PCAP) files, it should be understood that use of the PCAP format is an exemplary embodiment, and that embodiments of the present disclosure can include input, transformation, and output relating to any type of capture file.

In one embodiment, the Net-CAE system can use software written in the C language to be run on a POSIX-compliant operating system. As appreciated by those skilled in the art, many and varied software languages and operating systems are applicable to make and use the system of the present disclosure.

Assuming the above embodiment, the main data structure that accumulates information regarding metrics that is used to produce the output file (e.g., the CSV file) can include a dynamic, re-sizable array of structures, which in turn contain data variables, further arrays, structures or binary-trees. The structure can grow in response to the analysis of the packets in the PCAP and/or other capture files.

The growth can include, for example, the addition of PCAP or other capture files, additional VLANs within a capture file, additional IEEE Ethernet MAC Layer-2 addresses within a capture file, additional ICANN/IANA IPv4 or IPv6 layer-3 addresses within a capture file, additional ICANN/IANA Layer-3 protocols within a capture file, and/or additional ICANN/IANA Layer-4 protocols within a capture file.

Many of the data types, such as addresses, represent large sparsely-populated systems and are best processed through binary-trees. More compact data types can be processed through arrays.

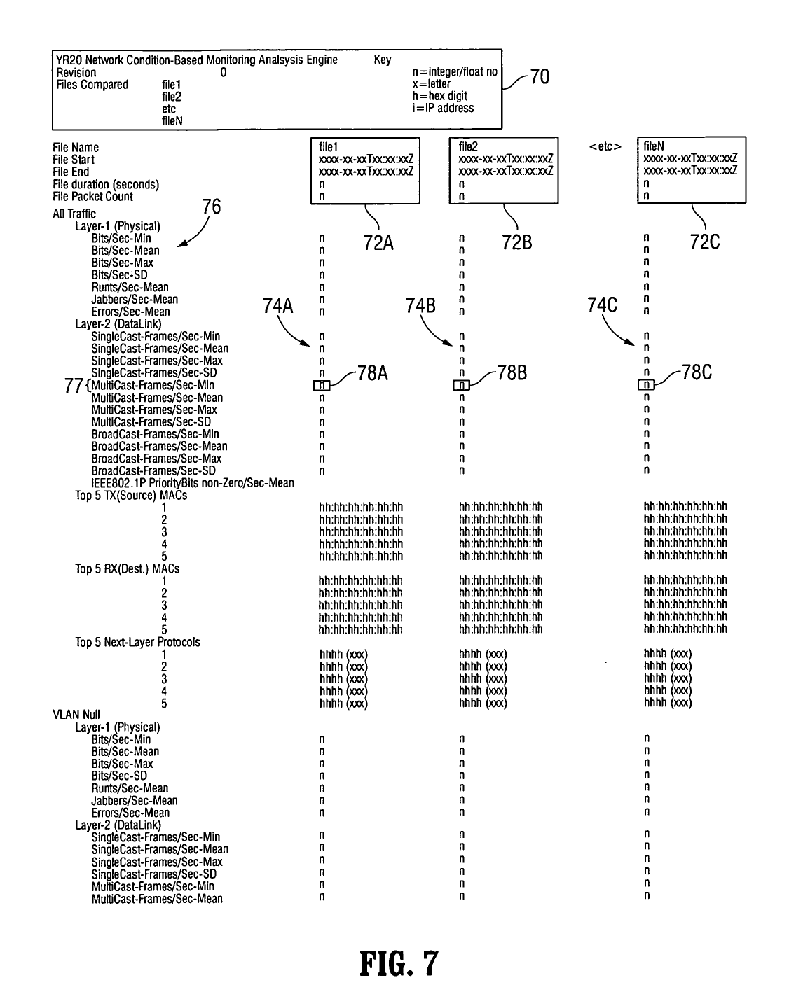

FIG. 7 illustrates an exemplary output associated with the network condition-based monitoring analysis engine of the present disclosure. Particularly, by way of example, FIG. 7 depicts a spreadsheet obtained by opening and reading an output CSV file produced using the Net-CAE engine using OpenOffice Calc software.

Typically, the output has a header (70) containing metadata, an information key, and/or identifying information relating to the files associated therewith. The main body of the output is in the form of a matrix, array, etc. The matrix can include column headers (72A, 72B, 72C), each listing a capture file that has been analyzed and associated metadata and/or information, such that data values relating to each capture file are listed in respective columns (74A, 74B, 74C) below the associated headers (72A, 72B, 72C). Similarly, each row of the depicted output includes identifiers (76), listing the particular metric to which each row relates. For reference a single row (77) is labeled, the intersection of the row (77) and each depicted column (74A, 74B, 74C) defining cells (78A, 78B, 78C). Thus, the body of the output matrix can show the value of a particular metric in a particular capture file in each cell. For example, the first cell (78A) shows the value of the metric associated with the row (77) for the capture file associated with first column (74A). Similarly, the second and third labeled cells (78B, 78C) show the values of the metric associated with the row (77) for the capture files associated with the second an third columns (74B, 74C), respectively. While FIG. 7 shows three columns, any number of columns can be included in the depicted matrix, one per capture file. Similarly, any number of rows can be used, as needed, to accommodate for the number of VLANs and/or metrics associated with the capture files.

The individual cells of the matrix can contain values such as, for example, an integer number, a Date/Time in ISO8601 format, hexadecimal representations of IEEE Ethernet Medium Access Control (MAC) Layer-2 addresses, hexadecimal representations of ICANN/IANA IPv6 Layer-3 addresses, and dotted-decimal representations of ICANN/IANA IPv4 Layer-3 addresses.

Many of the integer metrics may be presented as a rate per second (or other intervals as desired). This allows for the effective analysis of both capture files with different sizes or lengths.

While certain exemplary embodiments have been described in details and shown in the accompanying drawings, it is to be understood that such embodiments are merely illustrative of and not devised without departing from the basic scope thereof, which is determined by the claims that follow.

We claim:

1. A computer-implemented method for transforming data associated with at least one capture file for facilitating analysis thereof, the method comprising the steps of:
receiving raw data associated with at least one capture file, wherein the raw data comprises metrics associated with said at least one capture file;
transforming the raw data to form an array, wherein the array associates said at least one capture file with respective metrics associated with said at least one capture file; and
outputting the array for facilitating commissioning, documenting, monitoring, managing, analysis, repairing, modification, optimization, securing, or combinations thereof, of a network associated with the raw data.

2. The computer-implemented method of claim 1, wherein the step of receiving the data associated with said at least one capture file comprises receiving a first capture file associated with a test point of a network at a first time and at least one of: a second capture file associated with the test point of the network at a second time and a reference capture file associated with a standard, and
wherein the step of transforming the data to form the array comprises providing the array with a first axis associated with the first capture file, the second capture file, the reference capture file, or combinations thereof, and a second axis associated with respective metrics associated with the first capture file, the second capture file, the reference capture file, or combinations thereof.

3. The computer-implemented method of claim 1, wherein the step of receiving the data associated with said at least one capture file comprises receiving a plurality of capture files associated with a test point of a network, wherein each of said capture files is received at a respective time, and
wherein the step of transforming the data to form the array comprises providing the array with a first axis associated with the plurality of capture files and the respective times and with a second axis associated with respective metrics associated with the plurality of capture files.

4. The computer-implemented method of claim 1, wherein the step of outputting the array comprises displaying a plurality of columns, each of said columns associated with a respective capture file, and displaying a plurality of rows, each of said rows associated with a respective metric, thereby defining a plurality of cells, wherein each cell contains a value corresponding to the respective capture file of a column and the respective metric of a row.

5. The computer-implemented method of claim 1, wherein the step of outputting the array comprises displaying a plurality of rows, each of said rows associated with a respective capture file, and displaying a plurality of columns, each of said columns associated with a respective metric, thereby defining a plurality of cells, wherein each cell contains a value corresponding to the respective capture file of a row and the respective metric of a column.

6. The computer-implemented method of claim 1, wherein the step of transforming the data to form the array comprises:
performing a pre-process looping read through said at least one capture file to verify that said at least one capture file comprises valid inputs;
building data structures for retaining data associated with said at least one capture file;
sequentially analyzing packets associated with said at least one capture file and providing data associated with metrics of the packets to the data structures; and
writing the data to the array for output.

7. A computer-implemented method for transforming data associated with at least one capture file, the method comprising the steps of:
capturing a first capture file associated with a test point of a network at a first time and a second capture file associated with the test point of the network at a second time;
processing the first capture file to obtain first data associated with a first plurality of metrics;
processing the second capture file to obtain second data associated with a second plurality of metrics;
transforming the first data and the second data to form an array comprising cells, wherein each cell of the array is associated with a respective capture file and a respective metric of the respective capture file; and
outputting the array.

8. The computer-implemented method of claim 7, further comprising the steps of processing a reference capture file to obtain reference data associated with a plurality of reference metrics, and wherein the step of transforming the first data and the second data further comprises transforming the reference data to form the array, wherein at least one cell of the array is associated with the reference capture file and a reference metric of the reference capture file.

9. The computer-implemented method of claim 7, wherein the step of outputting the array comprises displaying a plurality of columns, each of said columns associated with a respective capture file, and displaying a plurality of rows, each of said rows associated with a respective metric, and wherein each cell contains a value corresponding to the respective capture file of a column and the respective metric of a row.

10. The computer-implemented method of claim 7, wherein the step of outputting the array comprises displaying a plurality of rows, each of said rows associated with a respective capture file, and displaying a plurality of columns, each of said columns associated with a respective metric, and wherein each cell contains a value corresponding to the respective capture file of a row and the respective metric of a column.

11. The computer-implemented method of claim 7, wherein the step of transforming the first data and the second to form the array comprises:
performing a pre-process looping read through the first and second capture files to verify that the first and second capture files comprise valid inputs;
building data structures for retaining data associated with the first and second capture files;
sequentially analyzing a first plurality of packets associated with the first capture file and providing data associated with metrics of the first plurality of packets to the data structures;
sequentially analyzing a second plurality of packets associated with the second capture file and providing data associated with metrics of the second plurality of packets to the data structures; and
writing the data to the array for output, wherein a first row or column of the array comprises data associated with the first capture file, and wherein a second row or column of the array comprises data associated with the second capture file.

12. A computer readable medium comprising computer instructions for instructing a processor to:
receive data associated with at least one capture file, wherein the data comprises metrics associated with said at least one capture file;
transform the data to form an array, wherein the array associates said at least one capture file with respective metrics associated with said at least one capture file; and
output the array.

13. The computer readable medium of claim 12, further comprising computer instructions for instructing the processor to:
receive a first capture file associated with a test point of a network at a first time and at least one of: a second capture file associated with the test point of the network at a second time and a reference capture file associated with a standard; and
provide the array with a first axis associated with the first capture file, the second capture file, the reference capture file, or combinations thereof, and a second axis associated with respective metrics associated with the first capture file, the second capture file, the reference capture file, or combinations thereof.

14. The computer-readable medium of claim 12, further comprising computer instructions for instructing the processor to:
receive a plurality of capture files associated with a test point of a network, wherein each of said capture files is received at a respective time; and
provide the array with a first axis associated with the plurality of capture files and the respective times and with a second axis associated with respective metrics associated with the plurality of capture files.

15. The computer-readable medium of claim 12, wherein the computer instructions for instructing the processor to output the array further instruct the processor to:
display a plurality of columns, each of said columns associated with a respective capture file; and
display a plurality of rows, each of said rows associated with a respective metric, thereby defining a plurality of cells; and
populate each cell with a value corresponding to the respective capture file of a column and the respective metric of a row.

16. The computer-readable medium of claim 12, wherein the computer instructions for instructing the processor to output the array further instruct the processor to:
display a plurality of rows, each of said rows associated with a respective capture file; and
display a plurality of columns, each of said columns associated with a respective metric, thereby defining a plurality of cells; and
populate each cell with a value corresponding to the respective capture file of a row and the respective metric of a column.

17. The computer-readable medium of claim 12, further comprising computer instructions for instructing the processor to:
perform a pre-process looping read through said at least one capture file to verify that said at least one capture file comprises valid inputs;
build data structures for retaining data associated with said at least one capture file;
sequentially analyze packets associated with said at least one capture file to extract data associated with metrics of the packets;
provide the data to the data structures; and
write the data to the array for output.
